(19) United States
(12) Patent Application Publication
(10) Pub. No.: US 2025/0011178 A1
(43) Pub. Date: Jan. 9, 2025

(54) SYSTEM AND METHOD FOR THE PRODUCTION OF AMMONIA

(71) Applicant: Cambridge Enterprise Limited, Cambridge (GB)

(72) Inventors: Collin Smith, Cambridge (GB); Laura Torrente Murciano, Cambridge (GB)

(21) Appl. No.: 18/713,585

(22) PCT Filed: Oct. 12, 2022
(86) PCT No.: PCT/EP2022/078425

§ 371 Date: May 24, 2024

(30) Foreign Application Priority Data
Nov. 29, 2021 (GB) 2117184.8

(51) Int. Cl. C01C 1/04; C01C 1/00; F17C 11/00

(52) U.S. Cl. CPC C01C 1/0405; C01C 1/006; F17C 11/00

(57) ABSTRACT

There is provided a system for the production of ammonia, the system comprising: a reservoir for liquid ammonia or water; a first vessel configured to receive gaseous nitrogen and hydrogen feedstocks, the first vessel comprising an ammonia Core process synthesis catalyst and a first material for storing ammonia, a second vessel adjacent and in direct thermal communication with the first vessel, the second vessel comprising a second material for storing ammonia or water, and being in fluid communication with the reservoir for liquid ammonia or water; a third vessel comprising a third material for storing ammonia and comprising an outlet for recovering ammonia; wherein the system has at least two operating modes, wherein: (i) in a first operating mode for retaining ammonia synthesised on the catalyst the first vessel is not in fluid communication with the third vessel, and (ii) in a second operating mode the first vessel is in fluid communication with the third vessel for passing ammonia to the third material.

The present invention relates to a system and method for the production of ammonia. In particular, the system is optimised for producing ammonia with an improved energy efficiency. This is especially key for the production of ammonia in a distributed fashion. In addition, the system of the invention can be adapted for use in other chemical processes where temporary heat storage or reversible heat transfer is desired.

Ammonia has been a foundational chemical for human civilization since it was first synthesized industrially in the early 20th century. Its role as the primary component in synthetic fertilizers is responsible for the continued population growth in the last century.

The core Haber-Bosch (HB) loop process includes the conversion of nitrogen and hydrogen at high temperature (>400° C.) and pressure (>100 bar) using an iron-based catalyst. These conditions favour a sensible kinetic rate at the expense of low conversions (˜20%) due to the thermodynamic limitations. The reactor effluent is cooled, ammonia is condensed and the remainder is recycled in order to increase the ammonia yield. While the core process looks very similar today as it did 100 years ago, the process equipment has been optimized for consuming fossil fuels (mainly methane) as the hydrogen feedstock and utilizing the high-grade steam generated as a by-product to power equipment leading to high CO₂ emissions (1.7 tonne CO₂ per tonne NH₃).

In recent decades, the availability of renewable electricity and the desire for a general electrification of the chemical industry has revealed that industrial ammonia synthesis is operating at a false optimization when only fossil fuels are considered as an energy source. If ammonia synthesis can be effectively coupled with renewable electricity, it will not only lead to sustainable fertilizers but it will also open avenues for ammonia as a dense energy storage medium and potentially a new energy market.

The electric HB process, which produces hydrogen through electrolysis rather than from fossil fuels, can operate entirely from renewable energy with considerably lower CO₂ emissions (0.4 tonnes CO₂ per tonne NH₃), partially thanks to the use of highly efficient electric compressors rather than steam turbines. However, renewable energy can be frustratingly isolated and intermittent; therefore making it incompatible with the conventional HB process intended to operate at steady-state conditions for months using capital-intensive equipment. Currently, large battery stores and hydrogen tanks are required to create and interface between fluctuating renewable energy and a steady industrial process. A new small-scale and agile process is required to re-imagine the relationship between renewable energy and ammonia.

For renewable energy to be able to replace fossil fuels in a future Net Zero society, we need to align their intermittent production with energy demands. Ammonia is poised to become a central energy vector in the renewable energy economy over the next decades as it can store energy in its chemical bonds (in the same way than fossil fuels do) in the long-term (e.g. months/seasons).

Ammonia is currently produced in hundreds of millions of tons per year through the Haber Bosch process using fossil fuels as the hydrogen feedstock and fuel. The process is highly optimised and integrated with an overall energy efficiency of 81% (92% of its physical limit). It mainly achieves it by transferring heat energy in the form of steam between its units. This process does not present the characteristics of agility and small scale required to store renewable energy. Indeed, it has to run continuously and it is only efficient if producing thousands of tons of ammonia daily.

In recent years, the focus of innovation has been on decreasing the operating pressure of ammonia synthesis to =20 bar as well as replacing the ammonia condensation separation by absorption. Within this context, metal halides such as MgCl₂ and CaCl₂ can operate at high temperatures (˜300° C.) relative to conventional adsorbents, making potentially possible the combination of catalyst and absorbent in the same vessel for in situ ammonia separation-removing equilibrium limitations and the need to recycle unreacted nitrogen and hydrogen, as has been theoretically suggested previously. This technology simplifies the capital requirements of the process and the ability to adjust steady-state.

“Exceeding Single-Pass Equilibrium with Integrated Absorption Separation for Ammonia Synthesis Using Renewable Energy—Redefining the Haber-Bosch Loop” by Collin Smith and Laura Torrente-Murciano, Advanced Energy Materials, Volume 11, issue 13, 2003845, 28 Feb. 2021 (“Smith et al.” hereafter), describes a reactor for the production of Ammonia and the contents of this document are incorporated herein in its entirety. Smith et al. demonstrates for the first time the experimental feasibility of the integration of the synthesis and separation of ammonia by combining a catalyst and an absorbent to exceed single-pass equilibrium. A suitable ruthenium-based catalyst is designed using nanostructured ceria as support and caesium as electronic promoter capable of achieving low-temperature (˜300° C.) ammonia synthesis, overcoming the conventional hydrogen inhibition of previously reported catalysts and quickly approaching equilibrium at moderate pressure (20 bar). A unique absorbent is synthesized from MnCl₂ supported on silica with enhanced stability and resistance to decomposition.

As outlined in Smith et al, the inventors have recently demonstrated an agile and potentially small-scale process to produce ammonia using exclusively renewable energy, able to adapt to its intermittent and distributed production. This process integrates the synthesis and separation of ammonia in a single vessel with 70% overall energy efficiency (79% of its physical limit).

There is a desire for the provision of an improved system for the production of ammonia, especially one which improves still further the efficiency and/or which better lends itself to a distributed production network. It is an object of the present invention to address these problems, tackle the disadvantages associated with the prior art, or at least provide a commercially useful alternative thereto.

According to a first aspect there is provided a system for the production of ammonia, the system comprising:
a reservoir for liquid ammonia or water;
a first vessel configured to receive gaseous nitrogen and hydrogen feedstocks, the first vessel comprising an ammonia synthesis catalyst and a first material for storing ammonia,
a second vessel adjacent and in direct thermal communication with the first vessel, the second vessel comprising a second material for storing ammonia or water, and being in fluid communication with the reservoir for liquid ammonia or water;
a third vessel comprising a third material for storing ammonia and comprising an outlet for recovering ammonia;
wherein the system has at least two operating modes, wherein:
(i) in a first operating mode for retaining ammonia synthesised on the catalyst the first vessel is not in fluid communication with the third vessel, and
(ii) in a second operating mode the first vessel is in fluid communication with the third vessel for passing ammonia to the third material.

In the following passages different aspects/embodiments are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

The present invention provides a system for the production of ammonia. The system provides the necessary conditions and steps for synthesising ammonia, based on the provided nitrogen and hydrogen feedstock gases. The overall system described herein for single-vessel ammonia synthesis is composed of a core process, second layer process, and third layer process. The core process is that described in Smith et al. and the contents of its disclosure, particularly in relation to catalysts and absorbents, is incorporated herein in its entirety. The core process produces heat from the production of ammonia and the storage of ammonia in the first material. The present invention focuses on the second layer process to store energy for release of ammonia from the core process, and the third layer process to compress ammonia for storage using excess heat.

The present invention increases the energy efficiency of the novel technology from 70% to ˜88% (almost 100% of its thermodynamic limit) by transferring heat energy in space and time using materials (such as metal halides) through a process known as absorption. When ammonia is synthesised and separated in the first vessel, heat is stored in the second vessel. The heat is later released to fulfil the energy requirements of the ammonia delivery (second layer process) and its compression (third layer process).

Advantageously, the ammonia can be directly provided under pressure, such as at least 7.5 Bar, such that it can be stored as a liquid at room temperature without requiring the use of compressors. This provides an energy saving over conventional systems where the ammonia produced needs to be pressurised to achieve the necessary liquid form.

Advantageously, the system described herein relies on the use of high-temperature absorbents to buffer a chemical reaction and store useful, high-grade heat. The temperature control is, moreover, passive so it does not require dynamic reactor control—this is particularly desirable for small scale applications. Temperature control in a chemical reactor is conventionally a dynamic control process (i.e. flow rate of cooling water) rather than a passive buffer. With no heat loss (adiabatic), the absorbent has a passive response—as heat is generated faster in core process, the second material stores heat faster.

The first vessel is the main reaction chamber of the system. The system comprises a first vessel configured to receive nitrogen and hydrogen feedstocks. While, typically, the first vessel may be a single chamber, it may also take the form of a plurality of chambers provided in fluid communication with each other.

The nitrogen and hydrogen feedstocks are generally in the form of nitrogen and hydrogen gas and may be supplied separately or mixed together. Thus, the first vessel has one or more inlets for receiving nitrogen and hydrogen feedstocks. The first vessel also comprises an ammonia synthesis catalyst and a first material for storing ammonia. The ammonia synthesis catalyst and the first material for storage can be provided separately, or can be mixed together. Where there are a plurality of chambers forming the first vessel, these may each hold the ammonia synthesis catalyst or the first material. The synthesis catalyst and the first material can be provided together as a static or fluidised bed. The exact form of the catalyst will depend on the catalyst composition being used and would be readily determined by a person skilled in the art.

The system can be adapted for use with any ammonia synthesis catalyst. Preferably the ammonia synthesis catalyst is selected to produce ammonia at a reaction temperature of less than or equal to 400° C., more preferably less than 350° C. and more preferably less than 300° C. The lower the synthesis temperature, the more versatile the process becomes and, in addition, there is a broader range of suitable compatible absorbents available for use as the first, second and third materials (i.e. ammonia storage materials). Examples of suitable ammonia synthesis catalysts include iron-based catalysts, which are conventional in the HB process such as those having a composition comprising Fe₂O₃—Al₂O₃—CaO—K₂O and variations thereof, and a wide variety of Ru-based catalysts, such as compositions comprising Ru—Cs—CeO₂. The suitable Ru-based catalysts are described further in Smith et al.

The first material is used for storing ammonia. It should be noted that, strictly, the term “storing” as used herein refers to the reversible “separation” of ammonia into the material. The separated ammonia can be reformed and released as the conditions change. The first material may be any species which can reversibly absorb (or even adsorb) ammonia and then release the ammonia with a simultaneous release of energy.

While a wide range of materials may be suitable for use in absorbing (or adsorbing) ammonia, metal halides are especially preferred. This is because they have a particularly significant enthalpy change when absorbing and releasing ammonia. Moreover, because the metal halides are capable of absorbing more than one ammonia molecule per metal centre, it is possible to target different absorption changes to achieve the necessary differences between the first, second and third materials. That is, the enthalpy change associated with a transfer from MnCl₂ to MnCl₂·NH₃ is greater than the enthalpy change associated with a transfer from MnCl₂·NH₃ to MnCl₂·2NH₃. Thus, the first reaction may be best suited to use in the first vessel, whereas the second reaction may be best suited to use in the second vessel, where the targeted temperature and pressure are different.

As will be appreciated, the materials selected for each of the first, second and third materials can all be independently selected from the same type of ammonia absorbent (or adsorbent) materials. The specific selection in each case will depend on the scale of the apparatus and the different vessels, as well as the specific ammonia synthesis catalyst selected. However, based on the available ammonia absorption enthalpy data for each material, this is a straight-forward selection.

Preferably, each of the first, second and third materials are absorbents for ammonia. Preferably the first, second and third materials each comprise a metal halide, optionally wherein the metal halide has ammonia molecules absorbed thereon. That is, the system may rely in one vessel on the reversible transition between, for example, MnCl₂·2NH₃ to MnCl₂·4NH₃. Although metal halides are especially preferred, others suitable absorbents include carbon, alumina, MOFs, silica or liquid water. In particular, in a preferred embodiment, the second material may have water absorbed on it for use in the thermal cycling on the basis of water absorption and desorption.

When the first, second and third materials each comprise a metal halide, preferably each metal halide is selected from the list consisting of: chlorides, bromides and iodides of Cu, Sn, Ni, Sr, Co, Ba, Li, Mn, Ca, Mg, Fe, and Zn, preferably MnCl₂, CaCl₂, MgCl₂, FeCl₂, and ZnCl₂. An exemplary system could rely on the use of the same metal halide as each of the first, second and third materials, but rely on different levels of ammonia absorption to tune the enthalpy differences at each stage of the process.

Preferably the first, second and third materials (whether absorbents or adsorbents) are supported on an inert particulate support material. Suitable support materials include, for example, metal oxides, MOFs, zeolites, silica and carbon. Further examples include conventional catalyst support materials as are well known in the art in, for example, the automobile exhaust catalyst field. Most preferred support materials are silica and carbon and these are particularly suitable for supporting the metal halides discussed herein. Without wishing to be bound by theory, it is considered that the support material helps to disperse and improve the stability of the absorbents, improving the performance of the system as a whole.

The system also comprises a second vessel adjacent and in direct thermal communication with the first vessel. The second vessel is preferably provided as a jacket around the first vessel to help improve the heat transfer and to minimise thermal losses.

The second vessel comprises the second material for storing ammonia or water. The material is discussed in more detail above. It is most preferred that the second material is for storing ammonia, but the system can also operate on the same basis with water. Ammonia may advantageously have reduced degradation of the storage materials and is easier to obtain at an elevated vapour pressure. For brevity, the following discussion focuses on ammonia, but should be understood to encompass water as well.

The second vessel is in fluid communication with a reservoir for liquid ammonia or water. Preferably the second vessel and the reservoir form a sealed volume. That is, preferably the second vessel and the reservoir are sealed together such that they are under a shared (i.e. universal) pressure. This means that when the temperature rises in the second vessel and there would be a consequential pressure increase in the second vessel, the same pressure increase would occur in the reservoir. However, when the second material in the second vessel is heated and loses ammonia, the pressure in the second vessel and the reservoir would both increase, leading to more ammonia condensing into the reservoir counteracting the increase in pressure. When the second material is able to absorb ammonia, this leads to a reduction in the pressure in the second vessel and the reservoir, leading to more ammonia evaporating from the reservoir and counteracting the drop in pressure.

The reservoir associated with the second vessel can be operated at ambient temperature. In a preferred embodiment the second vessel may be heated with waste heat from the system to provide an elevated operating temperature. This helps to provide conditions under which it can uptake/release low temperature heat to evaporate/condense ammonia.

The system further comprises a third vessel comprising a third material for storing ammonia and comprising an outlet for recovering ammonia. The material is discussed in more detail above. The third vessel may be a separate chamber from the first and second vessels and, in this embodiment it must then be provided with separate heating means for the eventual release of ammonia. However, preferably, the third vessel is arranged around the second vessel as a jacket, spaced therefrom by a selective heat-transfer barrier. That is, the selective heat-transfer barrier can be switched between conducting heat and not conducting heat. The simplest embodiment of such a selective heat-transfer barrier is a spacer vessel arranged between the second and third vessels which may be filed with a fluid (e.g. air) or emptied to provide a vacuum to change its thermal conduction properties.

The system has at least two operating modes. As discussed below, preferably the system has at least three operating modes. The modes are generally distinct and the system will be in only one operating mode at a given moment.

In a first operating mode the system is configured to synthesise ammonia and the ammonia synthesised on the catalyst in the first vessel is retained on the first material. In this mode heat is generated by ammonia synthesis and its storage/absorption into the first material and heat is transfer into the second vessel, leading to the desorption of ammonia/water and its consecutive condensation into the reservoir. The first vessel in this mode is not in fluid communication with the third vessel. Rather, it is sealed such that it is only receiving the nitrogen and hydrogen feedstocks. In some embodiments it may be desired that the first vessel is not sealed, such that a recycle loop can be employed as the feedstocks flow over the catalyst.

In a second operating mode the input of the nitrogen and hydrogen feedstocks is halted and the synthesis stops. In this mode the first vessel is placed in fluid communication with the third vessel for passing ammonia to the third material. That is, a valve (or valves) is opened so that gases can pass between the first and third vessels. In practice, since the first vessel is much hotter than the third vessel, there will be a driving force for ammonia to desorb from the first material and absorb onto the cooler third material. This is especially the case because the heat previously stored in the second vessel will now be transferred back into the first vessel.

When switching between the first and second operating modes, there may be an additional mode in which the unreacted nitrogen and hydrogen are flushed from the first vessel before connecting to third vessel. This can be achieved by depressurising the first vessel or by applying a vacuum to the chamber.

In a third operating mode, the third vessel is not in fluid communication with the first vessel. The third vessel is then heated, such that the third material desorbs ammonia. This is then recovered from the outlet of the third vessel. As discussed above, this recovery can be at greater than 7.5 bar (preferably greater than 8 bar), such that the ammonia is recovered as a liquid with no requirement for additional compressors.

As discussed above, preferably the system further comprises a spacer vessel (or selective heat transfer barrier) separating the second vessel from the third vessel, wherein in the first and second operating modes the spacer vessel is maintained under vacuum to minimise heat transfer between the second and third vessels. The provision of the spacer vessel (or selective heat transfer material) permits a desirable version of the third operating mode wherein the first vessel is not in fluid communication with the third vessel, the spacer vessel is filled with a fluid, preferably air, to permit heat transfer between the second and third vessels, and ammonia is recovered from the outlet.

Preferably in the first and second operating modes, the third vessel is unheated. Nonetheless, it is also possible that a degree of additional heating may be provided to optimise the ammonia equilibrium in this vessel. In the third operating mode additional heat can help to remove the ammonia from the third vessel.

As discussed above, there is a need to select the first, second and third materials based on the operational needs of the system in each chamber. Preferably the first material is selected to store (separate) ammonia under the working temperature and pressure of the catalyst in the first vessel.

Preferably, in the first operating mode, the nitrogen and hydrogen entering the first vessel is pre-heated by the latent heat of ammonia leaving the second vessel. And in the second operating mode, the ammonia entering the second vessel is pre-heated by the ammonia leaving the first vessel.

Preferably the second material is selected to release ammonia when receiving heat from the first vessel. In particular, the material is preferably selected to have an equilibrium temperature at the pressure of the reservoir which is the target temperature of the first vessel, so that it can readily receive and release heat, and to have a high enthalpy of ammonia absoprtion. Preferably the second material will require an enthalpy of >10 kJ/mol ammonia.

Preferably the third material is selected to preferentially absorb ammonia released from the first material under the second operating mode. This selection will take into account the temperatures of the first and third vessels, and the equilibrium pressures thereof. The third material will also release ammonia of the desired pressure at the temperature of the available heat. The available heat is generally the temperature of the first and second vessels, but this could be supplemented with additional heating if required in some embodiments.

As will be apparent from the discussion of the invention, it is particularly key for the efficient operation of the system that the produced and consumed heat is efficiently transferred between the various different vessels. The careful control of this heat energy makes it possible to control whether a given material is absorbing or desorbing ammonia and can lead to the efficient recovery of liquid ammonia with a minimal energy cost. It is especially preferred that the second, spacer and third vessels are concentrically arranged in layers around the first vessel. This concentric arrangement of vessels, which can be seen as a number of jacketed chambers, ensures that heat energy is not lost from the system. A less preferred layered embodiment provided with insulation as-required can also be envisioned.

According to a further aspect there is provided a method for the production of ammonia using the system described herein, the method comprising:
(i) with the system in the first operating mode, introducing nitrogen and hydrogen into the first vessel under conditions whereby ammonia is synthesised on the catalyst and absorbed onto the first material with a simultaneous release of heat,
whereby heat transferred from the first vessel to the second vessel causes the second material to desorb water or ammonia into the reservoir for liquid ammonia or water; and then
(ii) with the system in the second operating mode, halting the introduction of nitrogen and hydrogen into the first vessel to stop the synthesis of ammonia,
whereby the first material releases ammonia into the third vessel for storage on the third material, and whereby the second material re-absorbs water or ammonia from the reservoir with a simultaneous release of heat.

Preferably the method further comprises ensuring that the first vessel is not in fluid communication with the third vessel, and heating the third vessel to cause the third material to desorb ammonia and recovering ammonia from the outlet.

Preferably the system comprises a spacer vessel separating the second vessel from the third vessel, wherein in the first and second operating modes the spacer vessel is maintained under vacuum to minimise heat transfer between the second and third vessels,
and wherein the system has a third operating mode wherein the first vessel is not in fluid communication with the third vessel, the spacer vessel is filled with a fluid, preferably air (preferably at ambient pressure), to permit heat transfer between the second and third vessels, and whereby heat transferred from the second vessel to the third vessel causes the third material to desorb ammonia, wherein the method comprises: (iii) with the system in the third operating mode, recovering ammonia from the outlet.

Preferably the method comprises having the system alternate between the first and second operating modes and, optionally, placing the system in the third operating mode after at least two repetitions of the first and second operating modes.

According to a further aspect there is provided a system for temporary heat storage from a cyclical chemical process, the system comprising:
a reservoir for ammonia or water;
a first vessel for containing a heat-producing chemical process; and
a second vessel adjacent and in direct thermal communication with the first vessel, the second vessel comprising a material for storing ammonia or water, and being in fluid communication with the reservoir for liquid ammonia or water;
wherein the system has at least two operating modes, wherein:
(i) in a first operating mode a heat-producing chemical process is performed in the first vessel, whereby heat passes from the first vessel to the second vessel causing the second material to desorb ammonia or water, and
(ii) in a second operating mode the heat-producing chemical process is halted, whereby heat passes from the second vessel to the first vessel and the second material reabsorbs ammonia or water from the reservoir.

As will be appreciated, this system for temporary heat storage relies on the use of the second vessel, second material and reservoir described above in relation to the first aspect described herein. That is, the discussion above regarding the second material applies equally to the material for storing ammonia or water discussed in this embodiment.

Advantageously, this provides passive rather than active heat storage. That is, the system for temporary heat storage acts as a natural “buffer” to maintain the temperature without active control—such as changing the flow rate of water/steam in a conventional chemical process. In other words, as the temperature get hotter from an exothermic reaction, the second vessel responds automatically to remove more heat (desorption speeds up), and then the reverse with an endothermic reaction as it cools down.

Examples of cyclical chemical processes include ammonia generation using absorption/desorption as discussed herein. Another example would be the synthesis and decomposition of ammonia (for hydrogen production and energy generation). However, it further encompasses other chemical reactions which benefit from cyclical performance, which includes chemical reactions which are intermittent high temperature processes that produce heat, but lose heat when not running (i.e. rather than consuming heat, heat is dissipated when the reaction is not taking place). Specific examples of these processes include electrolysers and fuel cells. That is, a cyclical chemical process is a chemical process which switches between at least first and second states (desorption/absorption, or on/off). Furthermore, the term “cyclical chemical process” includes embodiments with two or more complementary chemical processes which can be coupled together.

According to a further aspect there is provided a method for temporary heat storage from a cyclical chemical process using the system described above, the method comprising:
(i) with the system in the first operating mode, performing a heat-producing chemical process in the first vessel, whereby heat passes from the first vessel to the second vessel causing the second material to desorb ammonia or water, and then,
(ii) with the system in the second operating mode, halting the heat-producing chemical process in the first vessel, whereby heat passes from the second vessel to the first vessel and the second material reabsorbs ammonia or water from the reservoir.

Preferably the heat-producing chemical process discussed herein for the heat storage system and method are operated at a temperature of at least 100° C., preferably at least 200° C. and more preferably from 200° C. to 500° C., most preferably from 300° C. to 400° C.

### FIGURES

The invention will now be described further in relation to the following non-limiting figures, in which:

FIG. 1 shows a simplified graphic of the thermal processes taking place in the vessels of the inventive system.

FIG. 2 shows a detailed configuration of a system according to the present invention.

FIGS. 3A, 3B and 3C provide a more detailed analysis of the reactions taking place in each vessel.

FIG. 4 shows the ammonia absorbed on each material over time as cycles are performed.

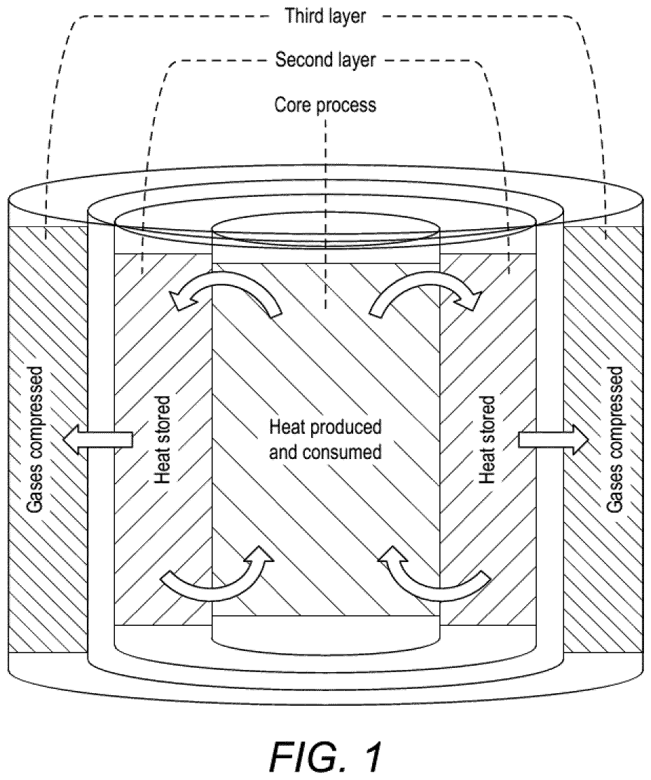

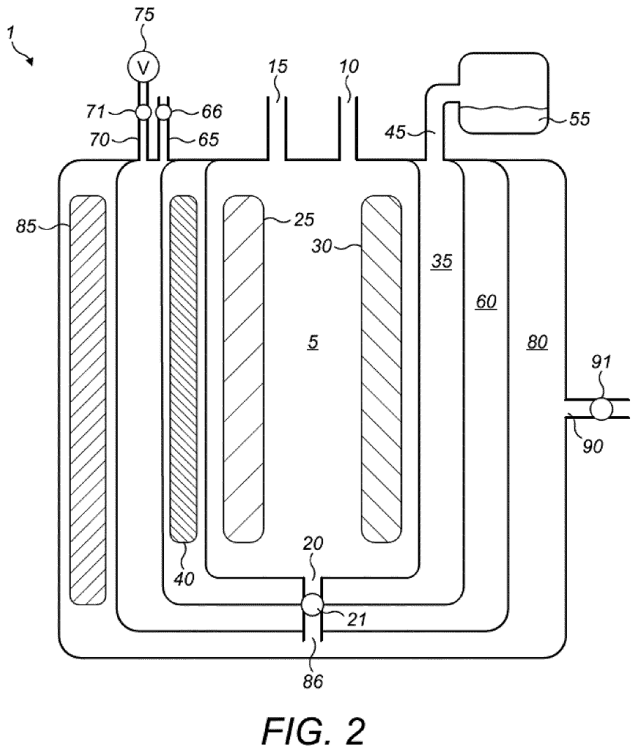

FIG. 2 shows an apparatus 1 for the production of ammonia. The apparatus may be run in each of three different operating modes as discussed below.

The apparatus 1 comprises a first vessel 5. Since the first vessel 5 is for performing a high temperature and pressure reaction, and is required to conduct heat, it is typically made of steel or the like. The first vessel 5 has an inlet 10 for receiving nitrogen gas and an inlet 15 for receiving hydrogen gas. The first vessel 5 also has an outlet 20 for recovering ammonia which may be closed by a valve 21.

The first vessel 5 contains a supported catalyst 25 for the production of ammonia. The first vessel 5 also contains a first material 30 for storing ammonia.

Around the first vessel 5 there is provided a second vessel 35 provided in the form of a jacket. The second vessel 35 may entirely contain the first vessel 5, be provided around and below, or just be provided around the outside (i.e. not above or below). The second vessel contains a second material 40 for storing ammonia and, in the first operating mode already storing an amount of ammonia. Since the second vessel 35 is for maintaining a pressure and also is required to conduct heat, it is typically made of steel or the like.

The second vessel 35 contains an outlet 45 which is in fluid communication with a reservoir 50 containing a liquid 55, i.e. ammonia. The second vessel 35 and the reservoir 50 together form a sealed system, such that it is not open to the atmosphere and the liquid 55 cannot be lost.

Around the second vessel 35 there is provided a spacer vessel 60 which is provided as a jacket. The spacer vessel 60 may entirely contain the second vessel 35, or just be provided around the outside (i.e. not above or below).

The spacer vessel 60 is provided with an inlet 65 connected by a valve 66 to the atmosphere and an outlet 70 connected by a valve 71 to a vacuum pump 75. Depending on the configuration of the valves 66 and 71 the spacer vessel 60 may be maintained under vacuum or filled with air.

Around the spacer vessel 60 there is provided a third vessel 80 in the form of a jacket. The third vessel 80 may entirely contain the spacer vessel 60, or just be provided around the outside (i.e. not above or below). The third vessel 80 contains a third material 85 for storing ammonia.

The third vessel 80 has an inlet 86 in fluid communication via the valve 21 with the outlet 20 of the first vessel 5. The third vessel 80 has an outlet 90 controlled by a valve 91 for the recovery of ammonia, preferably in a liquid form.

In the first operating mode valve 21 is closed, the spacer vessel 60 is held under vacuum and the valve 91 is also closed.

In the first operating mode, nitrogen gas is admitted into the first vessel 5 via the inlet 10 and hydrogen gas is admitted into the first vessel 5 via the inlet 15. Temperature and pressure are maintained in the first vessel 5 suitable for the production of ammonia when the nitrogen and hydrogen gases contact the supported catalyst 25. The production of ammonia is an exothermic process which releases heat into the first vessel 5.

At the same time, the first material 30 absorbs the produced ammonia. This is also an exothermic process which releases further heat into the first vessel 5.

The heat released in the first vessel 5 causes the second vessel 35 to also be heated. The introduction of the additional heat into this vessel causes the second material 40 to be heated. This causes the second material 40 to desorb ammonia. This is an endothermic reaction, so it removes heat from the second vessel 35. The desorbed ammonia increases the pressure in the closed system of the second vessel 35 and the reservoir 50, condensing a portion of the released ammonia into the liquid 55 of the reservoir 50.

The first operating mode may be performed until the second material 40 has substantially desorbed all of its ammonia or until the material 30 is saturated.

In the second operating mode valve 21 is opened, the spacer vessel 60 remains under vacuum and the valve 91 remains closed. Between the first and second operating modes, the first vessel 5 may be flushed by opening a further valve (not shown) to remove unreacted N₂ and H₂.

In the second operating mode, nitrogen gas stops being admitted into the first vessel 5 via the inlet 10 and hydrogen gas stops being admitted into the first vessel 5 via the inlet 15. This stops the production of ammonia and stops the release of heat from this reaction into the first vessel 5 from the catalyst. At the same time, since there stops being additional ammonia produced in the first vessel, the first material 30 stops absorbing ammonia and this also stops release of heat from this into the first vessel 5.

As the heat stops flowing from the first vessel 5 to the second vessel 35, the second material 40 starts to absorb ammonia from the reservoir 50. This is an exothermic reaction and produces heat which passes from the second vessel 35 to the first vessel 5. This means that the system 1 resists a decrease in temperature in the first vessel 5.

Since valve 21 is open providing a fluid communication between the first vessel 5 and the third vessel 80, there is a driving force for ammonia to leave the first material 30 and be absorbed on the third material 85. The energy required for the ammonia to leave the first material 30 (an endothermic reaction) is supplied by the heat passing from the second vessel 35 to the first vessel 5. Since the third material 85 is held at a lower temperature, the ammonia may preferentially move to the third material 85 from the first material 30. In any event, careful selection of the first, second and third materials (30, 40, 85) permits the optimisation of equilibrium ammonia absorption points which help to drive the process forwards.

Once the first material 30 is depleted in ammonia the system 1 returns to the first operating mode. Typically the system 1 switches several times between the first and second operating modes. After a number of cycles the system 1 moves to the third operating mode.

In the third operating mode valve 21 is closed, valve 66 is opened so that the spacer vessel 60 fills with air (and is then closed) and the valve 91 is opened.

Filling the spacer vessel 60 with air permits thermal conduction between the second vessel 35 and the third vessel 80. The conducted heat warms the third material 85, causing it to desorb the stored ammonia. This is released in a high purity and is recovered from the outlet 90.

When the third operating mode is concluded, valve 71 is opened and the vacuum pump 75 is run until the spacer vessel 60 is again under vacuum.

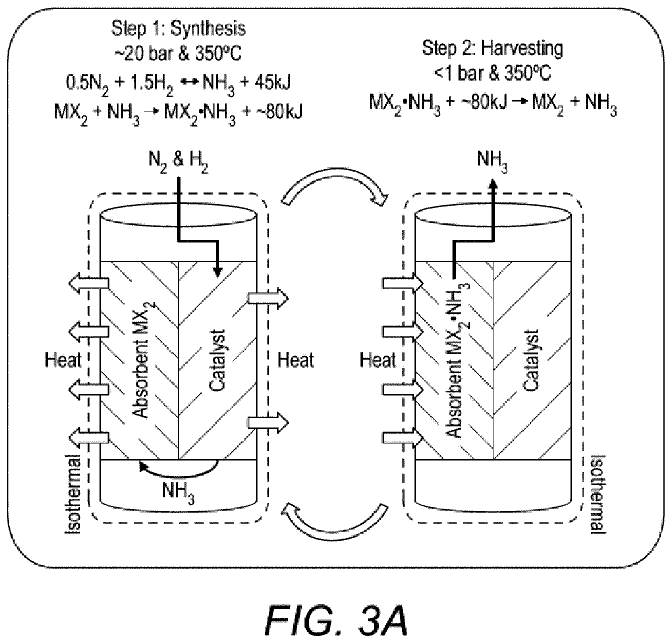

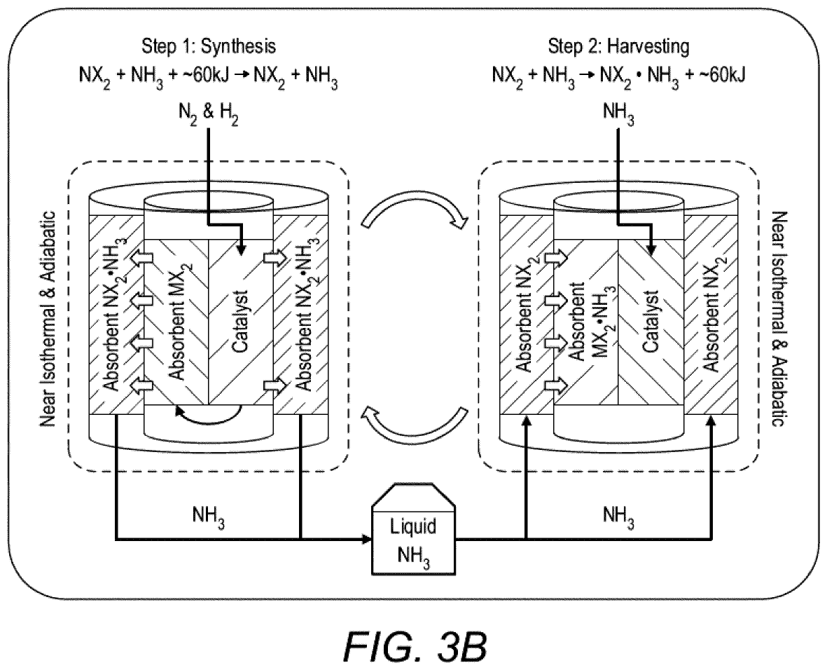

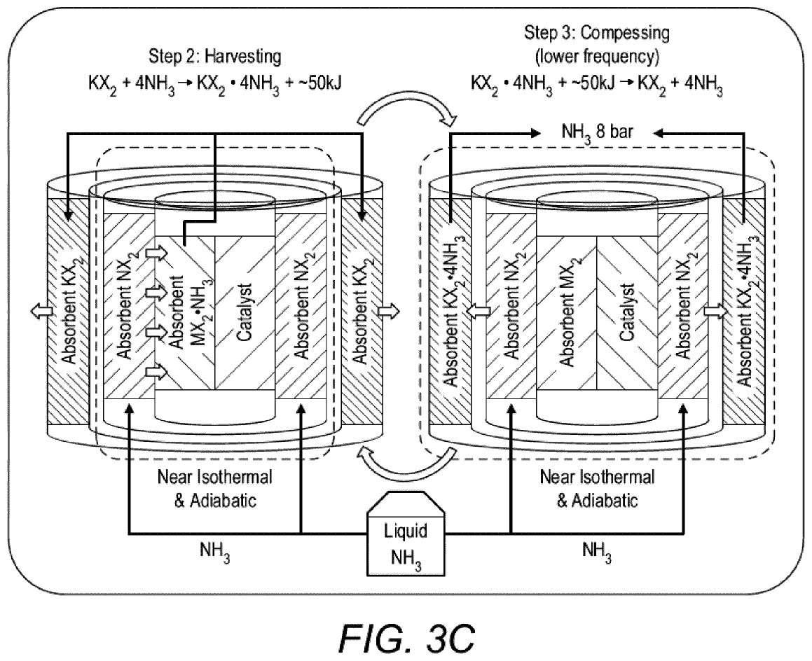

Although FIG. 2 looks at the process in terms of the operating mode, FIGS. 3A, 3B and 3C look at the reactions taking place in each of the three vessels 5, 35, 80 of the system 1.

The core process, performed in the first vessel, relies on the following reactions in the first operating mode:

0.5N₂+1.5H₂↔NH₃+45 kJ (i)

This typically is performed at ˜20 bar and ˜350° C.

MX₂+NH₃↔MX₂·NH₃+˜80 kJ (ii)

The core process, performed in the first vessel, relies on the following reactions in the second operating mode:

MX₂·NH₃+˜80 kJ↔MX₂+NH₃

This typically is performed at <1bar & >350° C.

The second and third vessels rely on the absorption and release of ammonia. The energy associated with this process depends on the absorbent used, but for a desirable metal halide it might be around 60 kJ in the second vessel and around 50 kJ in the third vessel.

MX₂+NH₃↔MX₂·NH₃+˜50-60 kJ (iii)

In FIGS. 3A-C the different metal halides are referred to as MX₂ (first material), NX₂ (second material), and KX₂ (third material) for clarity. Nonetheless, they may be any of the metal halides discussed herein.

### EXAMPLES

The invention will now be described further in relation to the following non-limiting example.

A system was considered having the following absorbents:
First vessel 5, MnCl₂ relying on the equilibrium between 0 and 1 absorbed NH₃ absorbent 1, also referred to as the first material 30.
Second vessel 35, MnCl₂ relying on the equilibrium between 1 and 2 absorbed NH₃ absorbent 2, also referred to as the second material 40.
Third vessel 80, MnCl₂ relying on the equilibrium between 2 and 6 absorbed NH₃. absorbent 3, also referred to as the third material 85.

In a typical set-up, the first step is to determine the equilibrium profile for each of the absorbents (30, 40, 85). The size of the first vessel 5 was such that it can contain a mixture with 1:3 ratio of catalyst:absorbent 1 (first material 30). The size of the second and third vessels 35, 80 are such that the ratio of absorbent 1 (first material 30):absorbent 2 (second material 40) and absorbent 1 (first material 30):absorbent 3 (third material 85) are 1:3 and 1:0.5, respectively. The void fraction of all vessels (5, 35, 80) is assumed to be 30%. The mass of catalyst 25 is 1 gram for the purpose of calculation, but it does not affect the final outcomes.

The initial conditions are i) the first and second vessel 5, 35 are at ˜330° C. which is the equilibrium temperature of the second absorbent (40) at the 9.8 bar vapour pressure of ammonia coming from the reservoir 50 at 25° C. (ambient temperature), ii) the third vessel 80 is at ambient temperature, and iii) the spacer vessel 60 is under vacuum.

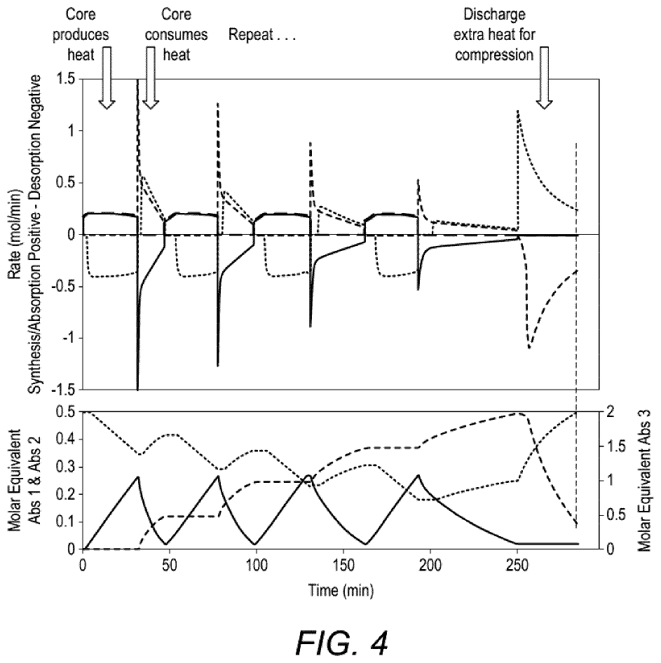

FIG. 4 shows the ammonia absorption and desorption of each component of the system. The production of ammonia on the catalyst 25 is the long-dash line which is always positive (or 0) and has four square-ish portions in the Figure. The desorption and reabsorption of ammonia on the second material is shown by the smallest dashes, which have square-ish negative regions, peaked and declining positive regions, including the final positive peak on the right hand side. The first material is shown in the solid line which overlaps the catalyst profile in the positive region and has sharp declining negative peaks. The third material is shown by the medium-dashes having declining positive peaks until the end of the profile with a single negative declining peak.

In the first operating mode, a mixture of nitrogen and hydrogen (at 2:3 N₂:H₂ ratio in this case) is added to the first vessel 5 at 30 bar, the catalyst 25 produces ammonia according to the rate equation developed previous (Smith et. al.), and additional N₂ and H₂ are added to maintain the same 30 bar total pressure. The latent heat of these gases is assumed to be negligible. Over time, the ammonia pressure increases until it reaches ˜0.6 bar and the absorbent 1 begins to remove ammonia according to the thermodynamic equilibrium and kinetic equations developed previously (Smith et. al.). At the temporary steady state, the rate of ammonia production and removal are identical, as shown by the overlapping long-dash (catalyst) and solid (absorbent 1) lines in the figure below.

As the catalyst and absorbent function in operating mode 1, they produce heat according to the established thermodynamics. This raises the temperature of the first vessel 5 according to the heat capacity of the catalyst 25 and absorbent 1. Once the temperature difference between the first and second vessels 5,35 exceeds the 10° C. necessary to transfer heat between vessels (i.e. the first vessel 5 is >340° C.), as is standard in chemical process design, heat is transferred to the second vessel 35 and the temperature of the second vessel rises according to the heat capacity of the second absorbent 40. This increase in temperature above 330° C. induces the second absorbent 40 to desorb ammonia according to the thermodynamic equilibrium and kinetic equations, indicated by a negative profile for the small-dash (second absorbent) line in FIG. 4. As the rate of desorption increases, the heat consumed matches the heat produced in the first vessel 5, and the first and second vessels 5, 35 operate at a temporary steady state.

Once the production of ammonia in the first vessel 5 drops to 90% of the maximum level in the operating mode, the system is switched to the second operating mode.

In the second operating mode, the first vessel 5 is connected to the third vessel 80 after flushing the interstitial gases leftover in the first vessel 5. Due to the low (initially zero) ammonia pressure, the first absorbent 30 begins desorbing ammonia (negative solid line in figure) and the ammonia pressure increases until it exceeds 0.04 bar and the third absorbent 85 begins absorbing ammonia according to the thermodynamic and kinetic equations (medium-dash) This rate increases with pressure until it equals the rate of desorption from the first absorbent 30.

As the first absorbent 30 desorbs ammonia, it consumes heat according to established thermodynamics. This drops the temperature of the first and second vessels 5,35 with a 10° C. difference again to <320° C. and <330° C., respectively, at which point the second absorbent 40 begins absorbing ammonia according to the equilibrium and kinetic equations (small-dash) and the temperature of the first and second vessels 5, 35 reaches a steady state. The temperature of the third vessel 80 is assumed to be constant at ambient temperature, with excess heat produced during absorption being discharged to the surroundings.

Once >95% of the ammonia in the first absorbent 30 is desorbed, the second operating mode is terminated, and the system returns to the first operating mode.

The first and second operating modes are repeated until the time required for the second operating mode has increased by 50% as a result of the third absorbent 85 filling with ammonia, decreasing the rate of ammonia absorption in the third absorbent 85.

In the third operating mode, the second vessel 35 is now in thermal exchange with the third vessel 80, through a method such as filling the spacer vessel 60 with agitated air. The temperature of the second vessel 35 drops an approximate 20° C. (to ˜310° C.) upon initial exchange of heat, which causes ammonia to be absorbed by the second absorbent 40. The heat produced during absorption in the second vessel 35 is discharged to the third vessel 80, which increases in temperature according to the heat capacity of the third absorbent 85. As the temperature of the third vessel 80 increases, it desorbs ammonia into the closed void space of the third vessel 80 according to its equilibrium pressure. Once the pressure of ammonia reaches the targeted 8 bar at an absorbent 3 temperature of ˜150° C., the third vessel 80 is opened to the liquefied ammonia storage until. The temperature of the third vessel 80 now remains constant as heat generated by the second absorbent 40 is being used only to desorb ammonia from the third absorbent 85 for final liquid storage. This process is continued until the second absorbent 40 returns to its initial value of ammonia capacity. In this specific case, as shown in the figure below, the second absorbent 40 returns to 0.5 molar equivalents of ammonia, at which point not all ammonia is removed from the third absorbent 85. As a result, some additional heat would be required to complete the cycle.

FIG. 4 shows the reaction rate and the molar equivalents, plotted against time. This shows the performance of cycles and the build-up and release of ammonia from the materials over time, especially as heat begins to build up in the first and second vessels.

The following chart provides some further exemplary configurations.

| | | | | | Percent of |
|---|---|---|---|---|---|
| | | | | | ammonia |
| | | | 1^{st} and 2^{nd} Vessel | | recovered using |
| # | 1^{st} Absorbent | 2^{nd} Absorbent | temperature range | 3^{rd} Absorbent | extra heat |
| 1 | MnCl₂—MnCl₂•NH₃ | MnCl₂•NH₃—MnCl₂•2NH₃ | 319-342° C. | MnCl₂•2NH₃—MnCl₂•6NH₃ | 85 |
| 2 | MnCl₂—MnCl₂•NH₃ | CaCl₂—CaCl₂•1NH₃ | 295-317° C. | MnCl₂•2NH₃—MnCl₂•6NH₃ | 85 |
| 3 | MnCl₂—MnCl₂•NH₃ | MgCl₂•1NH₃—MgCl₂•2NH₃ | 362-386° C. | CaCl₂•2NH₃—CaCl₂•4NH₃ | 100 |
| 4 | MnCl₂—MnCl₂•NH₃ | FeCl₂•1NH₃—FeCl₂•2NH₃ | 365-388° C. | ZnCl₂•4NH₃—ZnCl₂•6NH₃ | 95 |

*All examples assuming ammonia reservoir at ambient 25° C., no heat losses to environment (adiabatic), a pressure in vessel 5 of 30 bar, and a ratio of N₂:H₂ in vessel 1 of 2:3.

Although preferred embodiments of the disclosure have been described herein in detail, it will be understood by those skilled in the art that variations may be made thereto without departing from the scope of the disclosure or of the appended claims.

1: A system for the production of ammonia, the system comprising:
a reservoir for liquid ammonia or water;
a first vessel configured to receive gaseous nitrogen and hydrogen feedstocks, the first vessel comprising an ammonia synthesis catalyst and a first material for storing ammonia,
a second vessel adjacent and in direct thermal communication with the first vessel, the second vessel comprising a second material for storing ammonia or water, and being in fluid communication with the reservoir for liquid ammonia or water;
a third vessel comprising a third material for storing ammonia and comprising an outlet for recovering ammonia;
wherein the system has at least two operating modes, wherein:
(i) in a first operating mode for retaining ammonia synthesised on the catalyst the first vessel is not in fluid communication with the third vessel, and
(ii) in a second operating mode the first vessel is in fluid communication with the third vessel for passing ammonia to the third material.

2: The system according to claim 1, wherein the second vessel is formed as a jacket around the first vessel.

3: The system according to claim 1, further comprising a spacer vessel separating the second vessel from the third vessel, wherein in the first and second operating modes the spacer vessel is maintained under vacuum to minimise heat transfer between the second and third vessels,
and wherein the system has a third operating mode wherein:
(iii) in the third operating mode the first vessel is not in fluid communication with the third vessel, the spacer vessel is filled with a fluid, preferably air, to permit heat transfer between the second and third vessels, and ammonia is recovered from the outlet.

4: The system according to claim 3, wherein the spacer vessel is formed as a jacket around the second vessel and the third vessel is formed as a jacket around the spacer vessel.

5: The system according to claim 4, wherein the second, spacer and third vessels are concentrically arranged in layers around the first vessel.

6: The system according to claim 1, wherein, in the first and second operating modes, the third vessel is unheated.

7: The system according to claim 1, wherein the first, second and third materials each comprise a metal halide, optionally wherein the metal halide has ammonia molecules absorbed thereon.

8: The system according to claim 7, wherein each metal halide is selected from the list consisting of: chlorides, bromides and iodides of Cu, Sn, Ni, Sr, Co, Ba, Li, Mn, Ca, Mg, Fe, and Zn, preferably MnCl₂, CaCl₂, MgCl₂, FeCl₂, and ZnCl₂.

9: The system according to claim 1, wherein the first material is selected to store ammonia under the working temperature and pressure of the catalyst in the first vessel.

10: The system according to claim 1, wherein the second material is selected to release ammonia when receiving heat from the first vessel.

11: The system according to claim 1, wherein the third material is selected to preferentially absorb ammonia released from the first material under the second operating mode.

12: A method for the production of ammonia using the system according to any preceding claim, the method comprising:
(i) with the system in the first operating mode, introducing nitrogen and hydrogen into the first vessel under conditions whereby ammonia is synthesised on the catalyst and absorbed onto the first material with a simultaneous release of heat,
whereby heat transferred from the first vessel to the second vessel causes the second material to desorb water or ammonia into the reservoir for liquid ammonia or water; and then
(ii) with the system in the second operating mode, halting the introduction of nitrogen and hydrogen into the first vessel to stop the synthesis of ammonia,
whereby the first material releases ammonia into the third vessel for storage on the third material, and whereby the second material re-absorbs water or ammonia from the reservoir with a simultaneous release of heat.

13: A method according to claim 12, wherein the method further comprises ensuring that the first vessel is not in fluid communication with the third vessel, and heating the third vessel to cause the third material to desorb ammonia and recovering ammonia from the outlet.

14: The method according to claim 12, wherein the system comprises a spacer vessel separating the second vessel from the third vessel, wherein in the first and second operating modes the spacer vessel is maintained under vacuum to minimise heat transfer between the second and third vessels,
and wherein the system has a third operating mode wherein the first vessel is not in fluid communication with the third vessel, the spacer vessel is filled with a fluid, preferably air, to permit heat transfer between the second and third vessels, and whereby heat transferred from the second vessel to the third vessel causes the third material to desorb ammonia,
wherein the method comprises:
(iii) with the system in the third operating mode, recovering ammonia from the outlet.

15: The method according to claim 12, wherein the method comprises having the system alternate between the first and second operating modes and, optionally, placing the system in the third operating mode after at least two repetitions of the first and second operating modes.

16: A system for temporary heat storage from a cyclical chemical process, the system comprising:
a reservoir for ammonia or water;
a first vessel for containing an heat-producing chemical process; and
a second vessel adjacent and in direct thermal communication with the first vessel, the second vessel comprising a material for storing ammonia or water, and being in fluid communication with the reservoir for liquid ammonia or water;
wherein the system has at least two operating modes, wherein:
(i) in a first operating mode a heat-producing chemical process is performed in the first vessel, whereby heat passes from the first vessel to the second vessel causing the material to desorb ammonia or water, and
(ii) in a second operating mode the heat-producing chemical process is halted, whereby heat passes from the second vessel to the first vessel and the material reabsorbs ammonia or water from the reservoir.

17: A method for temporary heat storage from a cyclical chemical process using the system of claim 16, the method comprising:
(i) with the system in the first operating mode, performing a heat-producing chemical process in the first vessel, whereby heat passes from the first vessel to the second vessel causing the material to desorb ammonia or water, and then,
(ii) with the system in the second operating mode, halting the heat-producing chemical process in the first vessel, whereby heat passes from the second vessel to the first vessel and the second material reabsorbs ammonia or water from the reservoir.
